(19) United States
(12) Patent Application Publication
(10) Pub. No.: US 2019/0196793 A1
(43) Pub. Date: Jun. 27, 2019

(54) BUILDING ENTERPRISE MOBILE APPLICATIONS

(71) Applicant: SAP SE, Walldorf (DE)

(72) Inventors: PRAMOD SIDLAGHATTA JAIPRAKASH, Sandhausen (DE); Christine Hoerner, Karlsdorf-Neuthard (DE); Rick Weigel, Rheinstetten (DE); Benjamin Klehr, Kuppenheim (DE); Christian Boehrer, Hoepfingen (DE); Harald Kopf, Heidelberg (DE); Thomas Salvador, Oestringen (DE); Marcel Kassner, Hockenheim (DE); Markus Reetz-Lamour, Walldorf (DE); Antonia Gross-Tarakji, Sinsheim (DE)

(21) Appl. No.: 15/852,265

(22) Filed: Dec. 22, 2017

(51) Int. Cl. G06F 8/34; H04L 29/08

(52) U.S. Cl. CPC G06F 8/34; H04L 67/10; H04W 4/003; H04W 4/001

(57) ABSTRACT

Methods and system are disclosed that build or generate an enterprise mobile apps. In an aspect, a project package including multiple plugins, common functionalities, some functionalities, graphical user interface elements, etc., may be generated at a mobile application development framework (MADF). Further, the MADF may receive a request for building or generating an enterprise mobile app. The MADF may reuse the components of the project package and integrate with the application functionalities to generate a corresponding enterprise mobile app.

### BACKGROUND

Typically, creating a mobile application (also referred to as an app, mobile app, enterprise mobile app, enterprise mobile application, etc.) may necessitate a mobile app developer to have an in-depth knowledge of platform specific interfaces associated with an application development platform and/or tool. This may include having a know-how of the platform and/or tool specific features and functionalities, understanding compliance norms for using platform and/or tool specific features and functionalities, etc. Such need for in-depth knowledge may have drawbacks due to increased complexity of platform and/or tool specific functionalities, changes in compliance norms, etc., thereby making the process of app development inefficient and redundant. Therefore, it may be challenging to simplify the build or generation of mobile apps, such that the process of building or generating the mobile apps is harmonized by minimizing or eliminating redundant efforts and inefficiency.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an environment to build an enterprise mobile app, according to an embodiment.

FIG. 2 is a block diagram illustrating a system to build or generate an enterprise mobile application, according to an embodiment.

FIGS. 3A-3B are block diagrams showing reusability of a project package to build enterprise mobile applications, according to an embodiment.

FIG. 4 is a flow diagram showing a process to build an enterprise mobile application, according to an embodiment.

FIG. 5 is a block diagram illustrating a computer system, according to an embodiment.

### DETAILED DESCRIPTION

Embodiments of techniques related to building enterprise mobile applications are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “cone embodiment”, “this embodiment” and similar phrases, means that a feature, structure, or characteristic described in connection with the embodiment is included in at least one of the one or more embodiments. Thus, the appearances of these phrases in various places throughout this specification are not necessarily all referring to the same embodiment. Furthermore, the features, structures, or characteristics may be combined in any suitable manner in one or more embodiments.

Advancements in mobile technologies have propelled the number of mobile computing devices (such as personal digital assistants, enterprise digital assistants, smartphones, etc.) users. Further, such advancements have enhanced data processing and storage capabilities of, e.g., the smartphones. For example, the smartphones may include an operating system (e.g., Android®, Windows®, iOS®, etc.), that may provide access to respective mobile application distribution platforms (e.g., Google Play®, Windows Apps®, App Store®, etc.). The smartphones may connect with the mobile application distribution platform via a network (e.g., the Internet) and download the apps. An app may correspond to a bundled software application that may be executed on a mobile device, to provide specific operations or functionalities. When the app is triggered or instantiated, it may be executed on the mobile device to provide, for example, an interface (e.g., graphical user interface (GUI)), to receive user inputs, execute functionalities or process user requests and provide information or results that may be consumed by an end user. In an embodiment, the app may be built or generated using and/or reusing features and functionalities provided by a mobile application development framework (e.g., Apache® Cordova®), including application specific functionalities, common functionalities, etc. Typically, data or information related to a mobile app may be processed on client side (e.g., by the app on a mobile device) or on server side (e.g., remote servers deployed in cloud or/and on premise computing environments).

In an embodiment, building or generating the app may include building an executable application package (e.g., enterprise mobile application) or file by integrating components, scripts, routines, etc., that provide different functionalities. The integrated components may be compiled into a package as an executable file (e.g., including instructions associated with the different functionalities that may be executed by the processor of the mobile device) such that the integrated components, either independently or in cooperation, may facilitate execution of specific functionalities or operations. In an embodiment, the term enterprise mobile application may correspond to the app that may include functionalities. For example, a customer relationship management (CRM) system or application may facilitate managing relationships with the customers. The CRM system or application may manage the customer relationships via functionalities, such as solicitation (e.g., generating future customer prospects/leads through marketing), lead tracking (e.g., pre-sales—tracking customer responses, tracking sales leads, etc.), and relationship management (e.g., post-sale—prioritize responses, provide services, etc.). In an embodiment, the enterprise mobile application may be built or generated to include all or some of the referred functionalities.

In an embodiment, the terms software components or components, software routines or routines, software models or models, software engines or engines, software scripts or scripts, layers etc., may be used interchangeably throughout the specification, unless context warrants particular distinction(s) among the terms depending on implementation. The implementation primarily involves executing a computer readable code such as, a sequence of instructions by a processor of a computing device (e.g., a special purpose computer, a general-purpose computer, a mobile device, etc.) in an integrated environment (e.g., mobile application development framework). The computing device may function as the special purpose computer when the memory in the computing device stores instructions which when executed by the processor, provide execution of specific operations or functionalities. For example, such operations or functionalities, may not be limited to, but may include generating a project package by integrating plugins, graphical user interface elements, common functionalities, application specific functionalities, etc.; reusing components of the project package; generating configuration file; integrate functionalities and the configuration file to build or generate enterprise mobile application, etc. In an embodiment, the memory may store instructions that may not be limited to the aforementioned specific operations or functionalities. Unless the context warrants particular distinction(s), the cooperative execution of the referred arrangement of components, scripts, routines, etc., providing specific operations or functionalities may further improve the functioning of the special purpose computer. Further, the execution of the aforementioned specific operations or functionalities may also overcome the drawbacks or challenges, as described in the background section of the subject specification. Furthermore, the adaptation of the computing device to function as the special purpose computer may include executing the instructions to implement a mechanism to build or generate enterprise mobile applications. Such provision and utility provided by enterprise mobile apps may facilitate interaction between members of a team within a project, track status of projects, monitor potential problems, track data including financial details for the projects, etc.

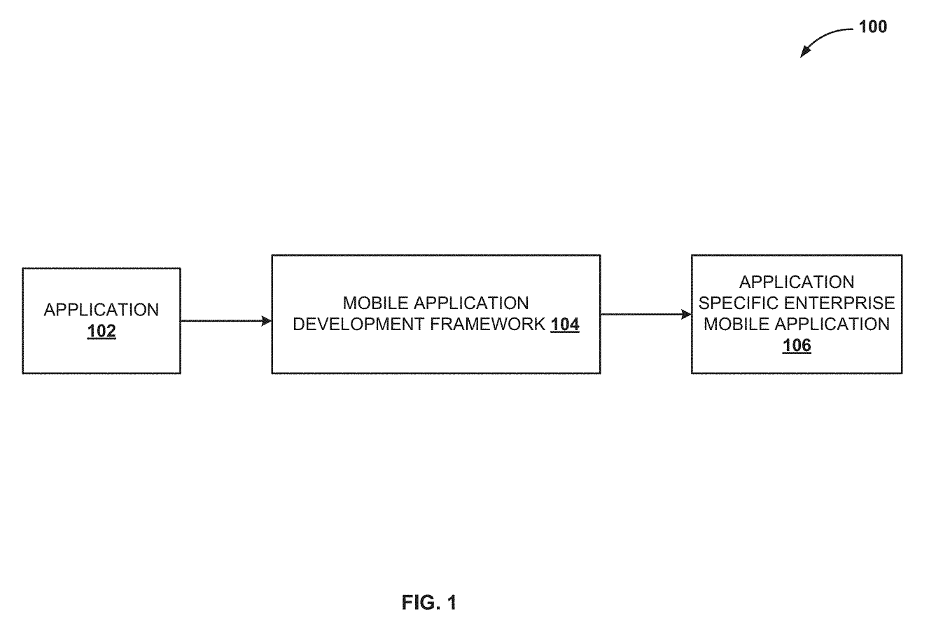

FIG. 1 is a block diagram illustrating system 100 to build an enterprise mobile app, according to an embodiment. FIG. 1 shows a system implementing a mechanism using mobile application development framework 104, to build or generate enterprise mobile application 106. In an embodiment, a project package including specific components (e.g., plugins, graphical user interface elements, etc.), common components (e.g., login via centralized login application) (not shown), an application (e.g., enterprise application; 102) or selected functionalities of application (e.g., 102), etc., may be integrated at mobile application development framework 104, to generate or build enterprise mobile application 106. The term ‘enterprise mobile application’ 106 may correspond to the enterprise mobile application that may include selected or multiple functionalities of application (e.g., 102).

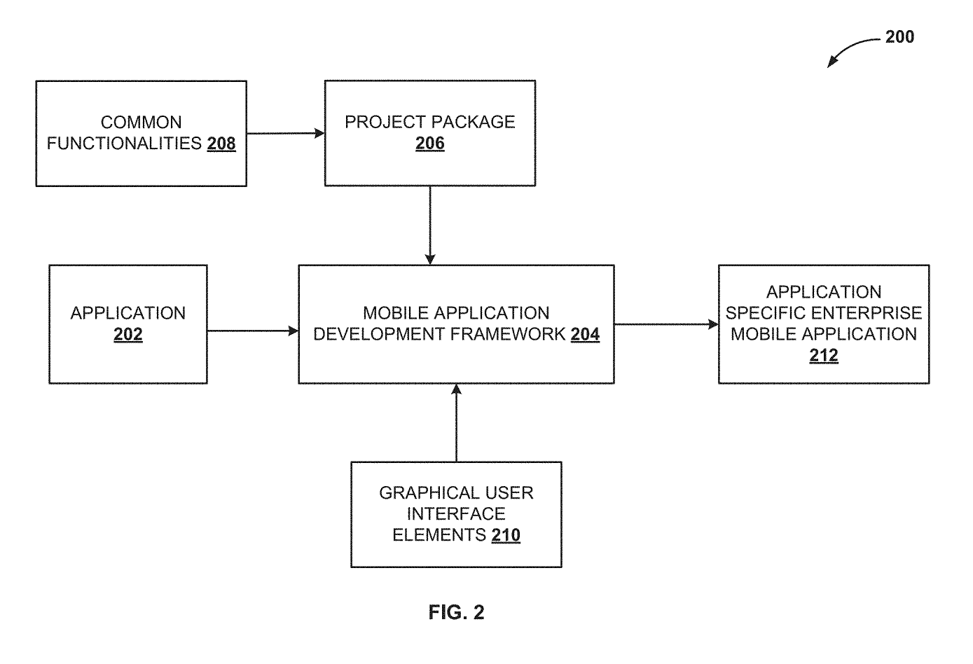

FIG. 2 is a block diagram illustrating system 200 to build or generate an enterprise mobile application, according to an embodiment. In an embodiment, an enterprise mobile application 212 may be built or generated by integrating multiple functionalities provided by components, such as, graphical user interface elements 210, application specific functionalities (e.g., application 202), common functionalities 208, plugins, etc. In an embodiment, a plugin may correspond to a software component that may provide or enhance specific feature or functionality. They provide an interface for mobile application development framework 204 and native components to communicate with each other and bindings to standard device Application Package Interface (APIs). The mobile application development framework 204 may provide a platform to facilitate seamless integration of components for building or generating enterprise mobile apps. The enterprise mobile application 212 may correspond to a bundled software application, that may be installed and executed at a mobile device and may provide multiple interfaces (e.g., GUI views or elements) to execute specific functionalities or operations. In an embodiment, application (e.g., 202, also referred to as enterprise application) may include an integration of software components, engines, scripts, routines, etc., that may provide specific operations or functionalities. The enterprise application (e.g., 202) may correspond to a system that may provision accessing, retrieving, and processing data by executing operations or functionalities on the data and provide information, that may be consumed by end users in the enterprise. The enterprise application (e.g., 202) may provide an interface to process, manage and structure data to provide useful information that may be consumed by end users in enterprises (e.g., private, public, etc.) or organizations (e.g., universities, educational organizations, etc.). In an embodiment, enterprise application (e.g., 202) may include an integration of user interface engines, software scripts, etc., including markup language (e.g., HTML5) for structuring and presenting content (e.g., data) via the World Wide Web (www). The markup language may provide syntactic features to facilitate seamless integration and working of multimedia and graphical content. In an embodiment, the content (e.g., data) may be consumed by the end users via web-browsers, application user interface elements, web-like view provided through mobile apps, etc.

In an embodiment, mobile application development framework 204 may provision building or generating enterprise mobile applications using markup programming and scripting. The markup programming and scripting may provide functionalities, for example, executing specific operations on data, extracting data, structuring unstructured data and rendering structured data on a user interface, etc. In an embodiment, the provision for building or generating the enterprise mobile application using the markup programming and scripting in the described mobile application development framework 204 may eliminate need for a mobile app developer from acquiring in-depth knowledge, for example, related to platform specific application program interfaces (APIs). For instance, such platform specific APIs may provision native features and/or functionalities that may be associated with specific operating systems, such as Android®, Windows®, iOS®, etc. In an embodiment, when the enterprise mobile app is built or generated using platform specific APIs, some of the native features and/or functionalities of the app may not optimally function on some mobile devices. In an embodiment, mobile application development framework 204 may provision developing or building enterprise mobile apps by wrapping or integrating functionalities or operations associated with enterprise application (e.g., application 202). The mobile application development framework 204 may additionally facilitate integration of other components and functionalities, such as common functionalities 208 (e.g., centralized login application), some or all functionalities (e.g., of application 202), graphical user interface elements 210, plugins, etc. The enterprise mobile apps may provision displaying the content like a web-view control on the enterprise mobile app, when the installed app is executed on the mobile device.

In an embodiment, a mobile application development framework specific project package (herein also referred to as project package 206) may be packaged and compiled (e.g., built or generated) by integrating multiple mobile application development framework specific plugins (also referred to as plugins), user interface elements, common functionalities 208, etc. The plugins, user interface elements, common functionalities 208, etc., in project package 206 may be customized and used when the enterprise mobile apps are built. In an embodiment, the term customizing or customization (e.g., of a component) may correspond to modifying an attribute (e.g., of the component), such that the customization (e.g., of the component) optimizes the functionality (e.g., of the component). Such optimization may provision the reusability of the component based on context specific functionality. In an embodiment, mobile application development framework 204 may receive a request for building or generating an enterprise mobile application. For example, an enterprise application (e.g., 202) may correspond to data processing and management systems for managing or executing specific functionalities. For example, the enterprise application may correspond to a Partner Relationship management (PRM). Enterprise Resource Planning (ERP), Customer Relationship Management (CRM), shopping cart application, expense report management application, etc.), analytical applications, ramp-up knowledge transfer learning applications, service mobile platform application, etc. The enterprise application (e.g., 202) may be multi-tiered and may include integrated components, scripts, software engines, etc., that work either independently or in cooperation. The enterprise application may be consumed or used by an end user via user interfaces, web-browsers, etc. In an embodiment, plugins of mobile application development framework 204 may provision accessing and/or using specific features, such as instantiating specific applications, features, etc., on mobile devices. For example, such plugins may facilitate or provide accessing mobile device's native features or applications such as, camera, calendar, push notifications; providing interfaces for execution or consumption of multimedia content (e.g. photos, videos, etc.); using microphone for recording voice, etc. The components of project package 206 including the plugins (e.g., associated with mobile application development framework 204), user interface elements, common functionalities, etc., may be customized (e.g., via a selection) and reused (e.g., utilize or reutilize) based on the requirements (e.g., desired functionalities) of the enterprise mobile applications. For example, consider a request for building an enterprise mobile application associated with a CIM application. In an embodiment, the CRM application may be deployed on an on-premise or on cloud computing environment and may work in cooperation with a common functionality, for example, a centralized login application (e.g., single sign-on) that may facilitate user authentication and may provision logging into the CRM application. The centralized login application may provision login functionality via a graphical user interface with graphical user interface elements (e.g., data fields, text fields, buttons, etc.), where a user may enter his/her input credentials (e.g., user name, password, email address, etc.). Upon logging into the CRM application, the CRM application may provide user interfaces for managing customer relationships. For example, managing customer relationships may include providing services and subsequently following up with the customer on the services provided by setting up appointments and/or meetings. In an embodiment, the CRM application may include a calendar application that may facilitate managing appointments and/or meetings. The calendar application may be instantiated to provide graphical user interface that may display dates and an interface to input, modify, delete, etc., content on the calendar. This may include modifying content to manage appointments or meetings with the customer.

In an embodiment, consider the team managing the customer relationships may desire to manage customer relationships via an enterprise mobile app. The mobile application development framework 204 may receive a request for building the enterprise mobile application (e.g., enterprise mobile application 212) including the corresponding functionalities of the CRM application (e.g., 202). To build or generate the enterprise mobile application, an end-user may use and/or reuse the components of project package 206 and the functionalities of the CRM application. For example, the components of project package 206 including common functionalities 208 (e.g., login), one or more graphical user interface elements 210 (e.g., buttons, data fields, text fields, etc.), and plugins (e.g., associated with calendar application) may be integrated to build the enterprise mobile application (e.g., 212). In an embodiment, the mobile application development framework 204 may provide the platform for integrating the above described components and/or functionalities of application (e.g., 202, 206, 208, and 210) via reusability of the components (e.g., plugins, graphical user interface elements, common functionalities, etc.) with the functionalities of the CRM application. The enterprise mobile application built or generated via the above described mechanism may therefore be referred to as enterprise mobile application 212 (e.g., that may include the above described functionalities of the CRM application). In an embodiment, the plugins in project package 206 may be associated with functionalities that may correspond to instantiating applications and/or providing accessing multiple features of the mobile device. The enterprise mobile applications may include an integration of specific components (e.g., plugins, common functionalities 208, etc.) from the project package and other functionalities to generate a configuration file. In an embodiment, the configuration file may be stored in a central repository that may be accessible by the mobile application development framework. Such application specific configuration file may be retrieved from the central repository into local memory associated with the mobile application development framework and terminal commands (e.g., associated with mobile application development framework) may be executed to initiate the integration and build of the application specific mobile enterprise application.

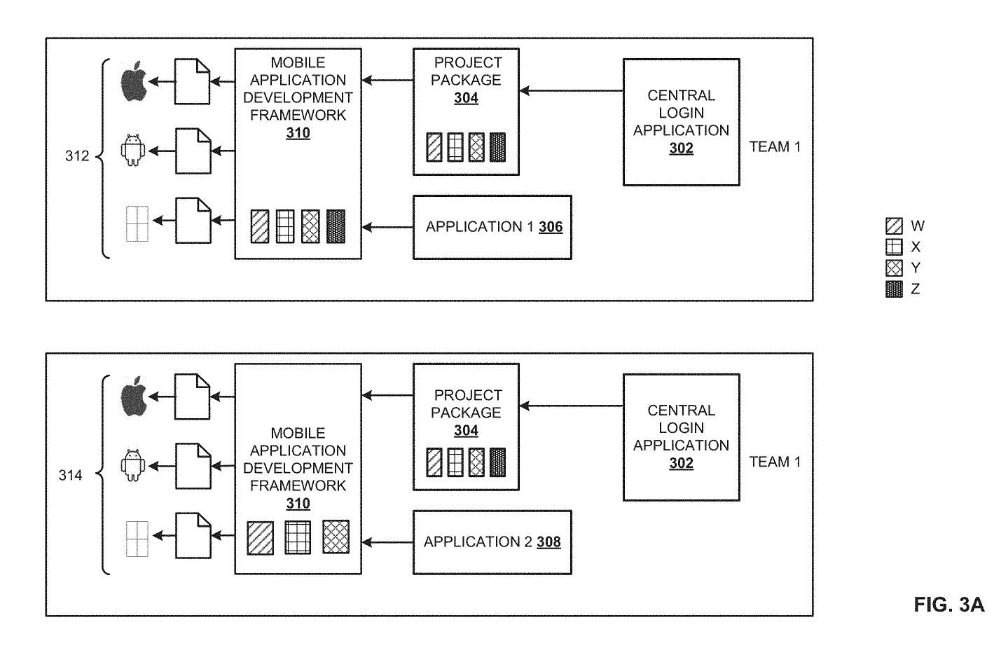

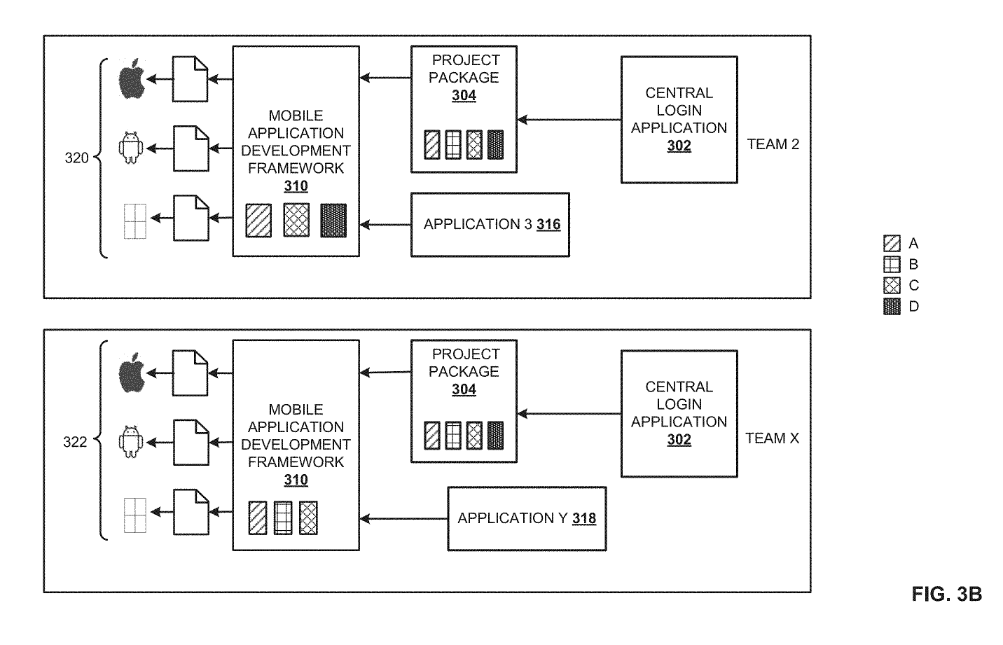

FIGS. 3A-3B are block diagrams showing reusability of a project package to build enterprise mobile applications, according to an embodiment. FIG. 3A and FIG. 3B show a mechanism for reusing components (e.g., plugins shown as ‘W’, ‘X’, ‘Y’ and ‘Z’ in FIG. 3A and ‘A’, ‘B’, ‘C’ and ‘D’ in FIG. 3B, graphical user interface elements, etc.) to build or generate multiple enterprise mobile applications (e.g., 312, 314, 320 and 322). In an embodiment. FIG. 3A shows team (e.g., Team 1) building enterprise mobile applications (e.g., 312 and 314) by reusing components in project package (e.g., 304). FIG. 3B shows teams (e.g., Team 2 and Team X) building enterprise mobile applications (e.g., 320 and 322) by reusing components in project package (e.g., 304). Some or all functionalities of the corresponding enterprise applications (e.g., app 1 306, app 2 308, app 3 316 and app Y 318) may be selected and integrated at mobile application development framework 310, to build or generate the corresponding enterprise mobile applications (e.g., 312, 314 in FIG. 3A and 320, 322 in FIG. 3B).

In an embodiment, the corresponding enterprise mobile applications (e.g., 312, 314 in FIG. 3A and 320, 322 in FIG. 3B) may integrate a common functionality, for example, login via a central login application 302, as shown in FIG. 3A and FIG. 3B. The common functionality (e.g., logging in via central login application 302) may be integrated into project package 304. The project package 304 including the reusable components (e.g., plugins shown as ‘W’, ‘X’, ‘Y’ and ‘Z’ in FIG. 3A, and ‘A’, ‘B’, ‘C’ and ‘D’ in FIG. 3B, graphical user interface elements, other common functionalities) and the corresponding applications (e.g., 306, 308, 316 and 318) or application specific functionalities (e.g., associated with applications 306, 308, 316 and 318) may be integrated at the mobile application development framework (e.g., 310), to build or generate the corresponding enterprise mobile applications (e.g., 312, 314 in FIG. 3A and 320, 322 in FIG. 3B). The plugins (e.g., shown as ‘W’, ‘X’, ‘Y’ and ‘Z’ in FIG. 3A, and ‘A’. ‘B’, ‘C’ and ‘D’ in FIG. 3B) may facilitate or provide accessing mobile device's native features or applications such as, camera, calendar, push notifications; providing interfaces for execution or consumption of multimedia content (e.g., photos, videos, etc.); using microphone for recording voice, etc. In an embodiment, the enterprise mobile applications (e.g., 312, 314 in FIG. 3A and 320, 322 in FIG. 3B) may be executable on multiple operating system platforms (e.g., Android®, Windows®, iOS®, etc.). In an embodiment, FIG. 3A shows enterprise mobile app 312 including an integration of plugins ‘W’, ‘X’, ‘Y’, ‘Z’; enterprise mobile app 314 including an integration of plugins ‘W’, ‘X’, ‘Y’. In an embodiment, FIG. 3B shows enterprise mobile app 320 including an integration of plugins ‘A’, ‘C’, ‘D’; enterprise mobile app 322 including an integration of plugins ‘A’, ‘B’, ‘C’. As described previously, the plugins shown in FIG. 3A and FIG. 3B may correspond to mobile device's native features or applications such as, camera, calendar, push notifications, providing interfaces for execution or consumption of multimedia content (e.g., photos, videos, etc.), using microphone for recording voice, etc.

In an embodiment, an enterprise mobile application may be built at a mobile application development framework by executing commands for integrating a configuration file. For example, such a configuration file may correspond to a project object model (POM) that may include information corresponding to contents of a project package, as well as other configuration information that may be used to build the enterprise mobile application. For example, the configuration information may correspond to plugins that may be associated with a mobile application development framework. In an embodiment, at the mobile application development framework, commands related to initialization and execution of a build lifecycle may be executed to build the enterprise mobile application. The execution of the commands may read the contents of the configuration file (e.g., project object model file) and integrate the components (e.g., application specific functionalities, common functionalities, plugins, graphical user interfaces, etc.), to build the enterprise mobile applications.

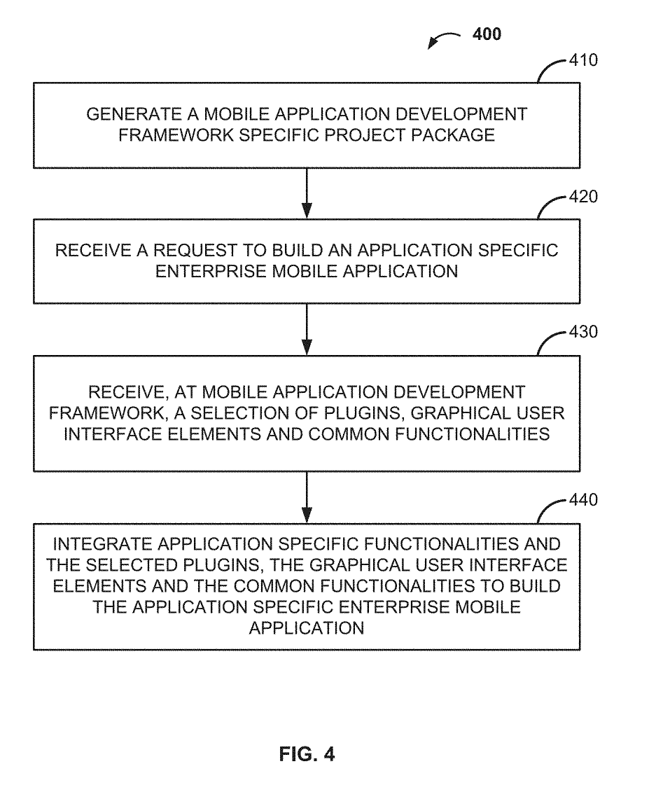

FIG. 4 is a flow diagram showing process 400 to build an enterprise mobile application, according to an embodiment. FIG. 4 shows process 400 that implements a mechanism to build or generate an enterprise mobile app. In an embodiment, a mobile application development framework specific project package is generated, at 410. In an embodiment, the mobile application development framework project specific package may include source files associated with an application and may be stored in a central repository. The central repository may be communicatively coupled with the mobile application development framework. The mobile application development framework project specific package may be accessed as a packaged project file that may be visible to an end user via integrated development environment (IDE, e.g., Eclipse) that may be communicatively coupled with the mobile application development framework. The mobile application development framework project specific package may be used to create platform specific mobile apps (e.g., executable files). As explained previously, the mobile application development framework specific project package may be packaged, compiled and may include an integration of plugins, multiple common functionalities, graphical user interface elements, etc. At the mobile application development framework, a request to build an enterprise mobile app is received, at 420. The plugins, graphical user interface elements, common functionalities, etc., from the project package are selected, at 430. The above selected components may be reused and the reuse functionality (e.g., plugins, common functionalities, etc.) may be selected based on the application for which an enterprise mobile application may be generated. An end user may select the reusable functionality (e.g., plugins, common functionalities, etc.) via the configuration file (e.g., project object model file) and integrate the components (e.g., application specific functionalities, common functionalities, plugins, graphical user interfaces, etc.), to build the enterprise mobile applications. In an embodiment, functionalities associated with application and selected plugins, graphical user interface elements, common functionalities, etc., are integrated, at 440, to build or generate the enterprise mobile application. The above described integration mechanism is automated that may be initiated by executing terminal commands associated with the mobile application development framework, to build or generate the enterprise mobile applications. In an embodiment, the operational efficacies of each of the steps (e.g., 410, 420, 430 and 440) of process 400 are as explained above and correspond to system 200 of FIG. 2.

In an embodiment, the above described mechanism to build or generate enterprise mobile applications by reusing the components of the project package, functionalities of the applications, features of the mobile application development framework, etc., may optimize the mechanism to build or generate the enterprise mobile application. For example, such optimization may be achieved by reusing the components of the project package. The reuse of the plugins, the graphical user interface elements, the common functionalities, the application specific functionalities, applications, etc., may reduce the efforts for developing/building the enterprise mobile application, need for having in-depth know-how and complexity of learning the mobile application development framework. In an embodiment, the enterprise mobile applications built via the mobile application development framework may provide a centralized platform for managing the plugins, seeking authorizations, complying with security norms, etc., thereby simplifying the mechanism to seek approvals and comply with norms formulated by governing bodies or authorities, etc. The enterprise mobile application may be configurable and may eliminate redundancy of the app development efforts and harmonize building the enterprise mobile applications. The provision of centralized platform for managing the plugins, seeking authorizations, complying with security norms, etc., may further optimize the enterprise mobile application development process by eliminating the need for multiple points of communication, reducing the memory consumed, etc., thereby harmonizing the enterprise application development process.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape, optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

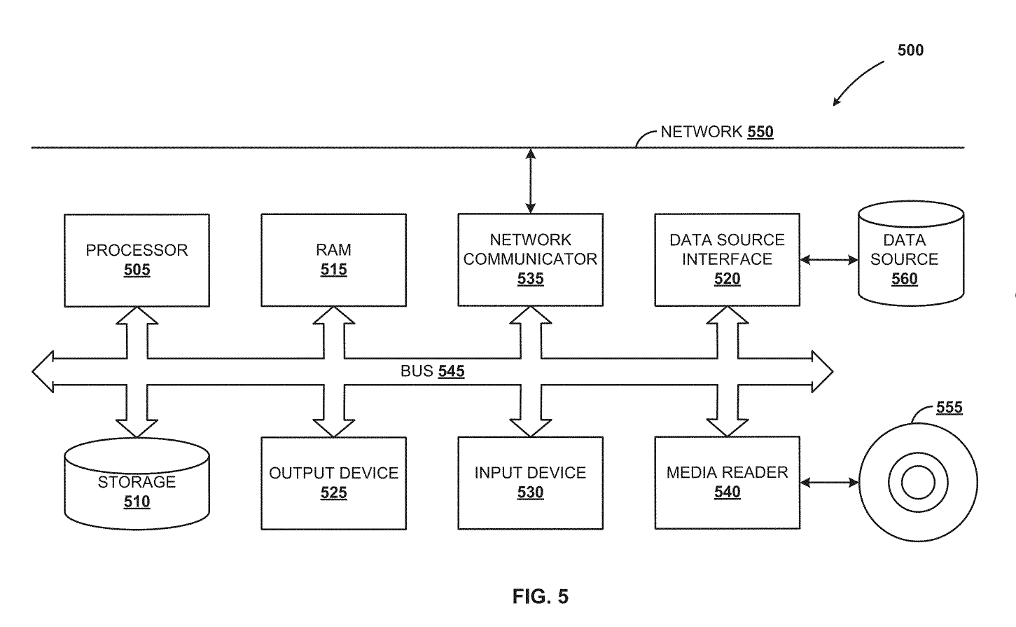

FIG. 5 is a block diagram illustrating a computer system 500, according to an embodiment. Computer system 500 includes processor 505 that executes software instructions or code stored on computer readable storage medium 555 to perform the above-illustrated methods. Processor 505 can include a plurality of cores. Computer system 500 includes media reader 540 to read the instructions from computer readable storage medium 555 and store the instructions in storage 510 or in random access memory (RAM) 515. Storage 510 provides a large space for keeping static data where at least some instructions could be stored for later execution. According to some embodiments, such as some in-memory computing system embodiments, RAM 515 can have sufficient storage capacity to store much of the data required for processing in RAM 515 instead of in storage 510. In some embodiments, all of the data required for processing may be stored in RAM 515. The stored instructions may be further compiled to generate other representations of the instructions and dynamically stored in RAM 515. Processor 505 reads instructions from RAM 515 and performs actions as instructed. According to one embodiment, computer system 500 further includes output device 525 (e.g., a display) to provide at least some of the results of the execution as output including, but not limited to, visual information to users and input device 530 to provide a user or another device with means for entering data and/or otherwise interact with computer system 500. Each of these output devices 525 and input devices 530 could be joined by one or more additional peripherals to further expand the capabilities of computer system 500. Network communicator 535 may be provided to connect computer system 500 to network 550 and in turn to other devices connected to network 550 including other clients, servers, data stores, and interfaces, for instance. The modules of computer system 500 are interconnected via bus 545. Computer system 500 includes a data source interface 520 to access data source 560. Data source 560 can be accessed via one or more abstraction layers implemented in hardware or software. For example, data source 560 may be accessed by network 550. In some embodiments data source 560 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

1. A computer system to build an enterprise mobile application, comprising:
a mobile application development project package comprising a plurality of plugins to access respective native applications of a type of mobile device, a plurality of graphical user interface elements and a plurality of common functionalities; and
a mobile application development framework to:
receive an enterprise application;
receive the mobile application development project package:
receive a user selection of at least one plugin from the plurality of plugins, at least one graphical user elements from the plurality of graphical user elements and at least one common functionality from the plurality of common functionalities; and
build an enterprise mobile application for the type of mobile device by automatically integrating functionalities of the enterprise application, the selected at least one plugin, the selected at least one graphical user element and the selected at least one common functionality.

2. The computer system of claim 1, wherein the selected at least one plugin, the at least one graphical user elements and the at least one common functionality are reused to optimize the build of the enterprise mobile application.

3. The computer system of claim 1, wherein the plurality of plugins is customizable and associated with:
the mobile application development framework; and
a plurality of features to access respective native applications of a type of mobile device.

4. The computer system of claim 3, wherein the native applications comprise one or more of a camera application, a calendar application, push notifications features, execution of multimedia content, a microphone or a combination thereof.

5. (canceled)

6. The computer system of claim 1, wherein the enterprise application is deployed in one of an on-premise computing environment and a distributed computing environment.

7. The computer system of claim 1, wherein the enterprise application comprises one or more of a customer relationship management application, an analytical application, an enterprise resource planning application, a partner relationship management application, a ramp-up knowledge transfer learning application, and a service mobile platform application.

8. A non-transitory computer readable storage medium tangibly storing instructions, which when executed by a computer, cause the computer to execute operations comprising:
receive, at a mobile application development framework, a mobile application development project package comprising a plurality of plugins to access respective native applications of a type of mobile device, a plurality of graphical user interface elements and a plurality of common functionalities;
receive, at the mobile application development framework, a request to build an enterprise mobile application for the type of mobile device and associated with an enterprise application;
receive, at the mobile application development framework, a user selection of at least one plugin from the plurality of plugins, one or more graphical user elements from the plurality of graphical user elements and at least one common functionality from the plurality of common functionalities; and
automatically integrate, at the mobile application development framework, functionalities of the enterprise application, the selected at least one plugin, the selected one or more graphical user elements and the selected at least one common functionality, to build the enterprise mobile application.

9. The non-transitory computer readable storage medium of claim 8, wherein the selected at least one plugin, the one or more graphical user elements and the at least one common functionality are reused to optimize the build of the at least one enterprise mobile application.

10. The non-transitory computer readable storage medium of claim 8, wherein the plurality of plugins is customizable and associated with:
the mobile application development framework; and
a plurality of features to access respective native applications of a type of mobile device.

11. The non-transitory computer readable storage medium of claim 10, wherein the native applications comprise one or more of a camera application, a calendar application, push notifications features, execution of multimedia content, a microphone or a combination thereof.

12. (canceled)

13. The non-transitory computer readable storage medium of claim 8, wherein the enterprise application is deployed in one of an on-premise computing environment and a distributed computing environment.

14. The non-transitory computer readable storage medium of claim 8, wherein the one enterprise application comprises one or more of a customer relationship management application, an analytical application, an enterprise resource planning application, a partner relationship management application, a ramp-up knowledge transfer learning application, and a service mobile platform application.

15. A computer implemented method, comprising:
generating a mobile application development project package comprising a plurality of plugins to access respective native applications of a type of mobile device, a plurality of graphical user interface elements and a plurality of common functionalities;
receiving, at a mobile application development framework, a request to build an enterprise mobile application associated with an enterprise application;
receiving, at the mobile application development framework, a selection of at least one plugin from the plurality of plugins, one or more graphical user elements from the plurality of graphical user elements and at least one common functionality from the plurality of common functionalities; and
building an enterprise mobile application for the type of mobile device by automatically integrating, at the mobile application development framework, functionalities of the enterprise application, the selected at least one plugin, the selected one or more graphical user elements and the selected at least one common functionality.

16. The computer implemented method of claim 15, wherein the selected at least one plugin, the one or more graphical user elements and the at least one common functionality are reused to optimize the build of the at least one enterprise mobile application.

17. The computer implemented method of claim 15, wherein the plurality of plugins is customizable and associated with:
the mobile application development framework; and
a plurality of features to access respective native applications of a type of a mobile device.

18. The computer implemented method of claim 17, wherein the native applications comprise one or more of a camera application, a calendar application, push notifications features, execution of multimedia content, a microphone or a combination thereof.

19. (canceled)

20. The computer implemented method of claim 15, wherein the enterprise application is deployed in one of an on-premise computing environment and a distributed computing environment.
